(19) United States
(12) Patent Application Publication
(10) Pub. No.: US 2016/0325750 A1
(43) Pub. Date: Nov. 10, 2016

(54) TRAVEL CONTROL APPARATUS

(71) Applicant: TOYOTA JIDOSHA KABUSHIKI KAISHA, Toyota-shi (JP)

(72) Inventors: Wataru KANDA, Shinagawa-ku (JP); Norihiro TAKAHASHI, Sunto-gun (JP); Tomoyuki KURIYAMA, Hadano-shi (JP)

(73) Assignee: TOYOTA JIDOSHA KABUSHIKI KAISHA, Toyota-shi (JP)

(21) Appl. No.: 15/131,468

(22) Filed: Apr. 18, 2016

(30) Foreign Application Priority Data
May 8, 2015 (JP) 2015-095862

(51) Int. Cl. B60W 30/18

(52) U.S. Cl. CPC B60W 30/18163; B60W 2600/00; B60W 2420/42; B60W 2420/52; B60W 2550/302; B60W 2550/10; B60W 2520/10; B60W 2520/14; B60W 2520/105

(57) ABSTRACT

The apparatus determines whether or not the preceding vehicle is travelling in the overtaking lane at a speed lower than a travelling speed of the host vehicle. In a case where it is determined that the preceding vehicle is travelling in the overtaking lane at the speed lower than the travelling speed of the host vehicle, the apparatus performs the travel control of overtaking the preceding vehicle under a predetermined condition. In this way, the travelling of overtaking the preceding vehicle is performed, and then, by the travelling at the speed in line with the travelling speed of the preceding vehicle, it is possible to suppress the deterioration of the traffic flow on the travelling path.

### TECHNICAL FIELD

The present invention relates to a travel control apparatus for a vehicle.

### BACKGROUND

In the related art, relating to a travel control of a vehicle, for example, as disclosed in Japanese Unexamined Patent Publication No. 2000-343980, an apparatus is known, which is configured to perform an autonomous driving control of a vehicle and to perform a travelling of overtaking a preceding vehicle during the autonomous driving control. In addition, in Japanese Unexamined Patent Publication No. 2005-035531, a technology is known, in which it is determined whether a preceding vehicle travels in a single travelling state or in a motorcade travelling state, and in a case in which a motorcade travelling state is determined, travel control is performed by determining whether or not to overtake the preceding vehicle travelling in an overtaking-banned lane while considering legal provisions.

### SUMMARY

However, in the apparatus or the like described above, there is a problem in that a traffic flow in the travelling path may deteriorate. That is, in a case where the preceding vehicle travels in an overtaking-banned lane at a low speed, if it is assumed that the control of overtaking the preceding vehicle is not performed, vehicles subsequent to the preceding vehicle become travelling in a row which results in deterioration of the traffic flow in the travelling path.

Therefore, in this technical field, it is desirable to develop a travel control apparatus that can perform a travel control of a vehicle while suppressing the deterioration of the traffic flow.

That is, a travel control apparatus in an aspect of the present invention is a travel control apparatus configured to restrict an overtaking of a preceding vehicle travelling ahead in the overtaking lane and to perform a travel control on the host vehicle when a host vehicle is travelling on a travelling path including a plurality of lanes having an overtaking lane. The travel control apparatus includes: a travelling path information acquisition unit configured to acquire travelling path information of a travelling path on which the host vehicle travels; a travelling state acquisition unit configured to acquire travelling state information, of the host vehicle and travelling state information of the preceding vehicle; a determination unit configured to determine whether or not the preceding vehicle is travelling in the overtaking lane at a speed lower than a travelling speed of the host vehicle and lower than a legal minimum speed based on the information acquired by the travelling path information acquisition unit and the travelling state acquisition unit; and a travel control unit configured to perform a travel control of overtaking the preceding vehicle on the host vehicle in a case where it is determined that the preceding vehicle is travelling in the overtaking lane at a speed lower than the travelling speed of the host vehicle and lower than the legal minimum speed. According to the apparatus, in a case where it is determined that the preceding vehicle is travelling in the overtaking lane at a speed lower than the travelling speed of the host vehicle and lower than the legal minimum speed, the travel control of overtaking the preceding vehicle can be performed. In this way, it is possible to suppress the deterioration of the traffic flow on the travelling path due to the preceding vehicle travelling at a low speed.

In addition, in this travel control apparatus, in a case where the preceding vehicle is travelling in the overtaking lane at a speed lower than the travelling speed of the host vehicle and not lower than the legal minimum speed, and when an intention of a driver of the host vehicle to overtake the preceding vehicle is recognized, the travel control unit may perform the travel control of overtaking the preceding vehicle on the host vehicle. In this case, in a case where it is determined that the preceding vehicle is travelling in the overtaking lane at a speed lower than, the travelling speed of the host vehicle and not lower than the legal minimum speed, and in a case where the intention of a driver of the host vehicle to overtake the preceding vehicle is recognized, the travelling of overtaking the preceding vehicle is performed. In this way, the overtaking control in accordance with the driving attention of the driver is enabled.

Furthermore, in this travel control apparatus, in a case where the preceding vehicle is travelling in the overtaking lane at a speed lower than the travelling speed of the host vehicle and not lower than the legal minimum speed, and when the preceding vehicle is in a state of deceleration, the travel control unit may perform the travel control of overtaking the preceding vehicle on the host vehicle. In this case, in a case where it is determined that the preceding vehicle is travelling in the overtaking lane at the speed lower than the travelling speed of the host vehicle and not lower than the legal minimum speed, and in a case where the preceding vehicle is in a state of deceleration, the travelling of overtaking the preceding vehicle is performed. In this way, by overtaking the preceding vehicle which is in the deceleration state and not in ordinary travelling state, it is possible to suppress the deterioration of the traffic flow on the travelling path.

According to the present invention, a travel control of a vehicle can be performed while suppressing the deterioration of the traffic flow.

### BRIEF DESCRIPTION OF THE DRAWINGS

FIG. 1 is a block diagram illustrating a configuration overview of a travel control apparatus in an embodiment of the present invention.

FIG. 2 is a flowchart illustrating travel control processing in the travel control apparatus in FIG. 1.

FIG. 3 is a diagram for describing a travelling operation in the travel control apparatus in FIG. 1.

FIG. 4 is a diagram for describing a travelling operation in the travel control apparatus in FIG. 1.

FIG. 5 is a diagram for describing a travelling operation in the travel control apparatus in FIG. 1.

FIG. 6 is a diagram for describing a travelling operation in the travel control apparatus in FIG. 1.

FIG. 7 is a diagram for describing a travelling operation in the travel control apparatus in FIG. 1.

### DETAILED DESCRIPTION

Hereinafter, an embodiment of the present invention will be described with reference to the drawings. In the description below, the same reference signs will be given to the same or similar elements and the description thereof will not be repeated.

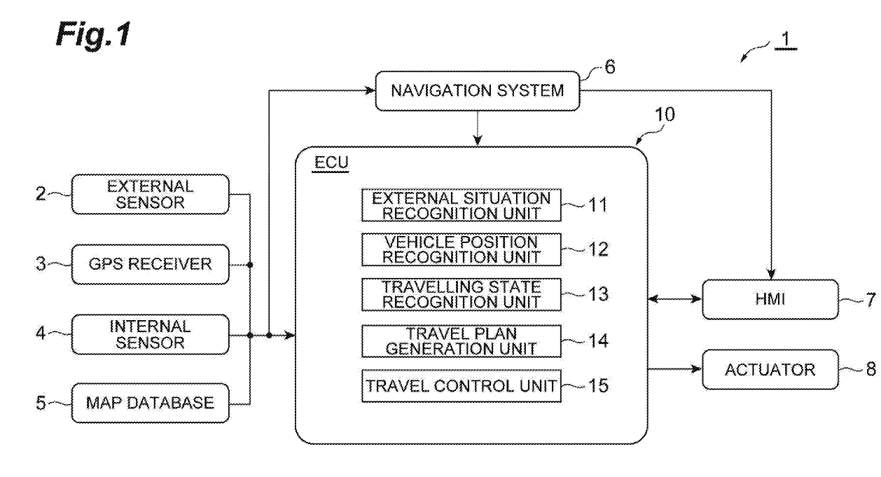

FIG. 1 is a block diagram illustrating a configuration overview of a travel control apparatus 1 in an embodiment of the present invention. In FIG. 1, the travel control apparatus 1 is an apparatus mounted on a host vehicle and performs a travel control of the host vehicle, and is applied to, for example, an autonomous driving control (automatic driving control) apparatus that performs autonomous driving along a lane. The travel control apparatus 1 performs a travel control on the vehicle by restricting an overtaking of the preceding vehicle travelling in an overtaking lane in advance in a case where the vehicle is travelling on a travelling path having a plurality of lanes including the overtaking lane. That is, in a case where the vehicle is travelling in the overtaking lane, the travel control apparatus 1 prohibits the overtaking of the preceding vehicle in principle and performs the travel control of overtaking the preceding vehicle under a predetermined condition. In addition, the travel control apparatus 1 is an apparatus performing the travel control on the vehicle by restricting the overtaking of the preceding vehicle in the overtaking lane, and it is different from an apparatus that does not perform restriction, of overtaking of a preceding vehicle, and thus, it is not applied to such an apparatus.

In addition, as long as the travel control apparatus 1 performs the travel control mainly as a control system while recognizing the preceding vehicle, the apparatus can be applied to any autonomous driving control apparatus without any limitation, and thus, it may be applied to a drive assistance control apparatus. In the present embodiment, the description will be made with an example of applying the apparatus to the autonomous driving control apparatus.

The travel control apparatus 1 includes an electronic control unit (ECU) 10. The ECU 10 is an electronic control unit for controlling travelling of a vehicle and is formed of mainly as a computer including a central processing unit (CPU), a read only memory (ROM), a random access memory (RAM). Details of the ECU 10 will be described below.

An external sensor 2, a global positioning system (GPS) receiver 3, an internal sensor 4, a map database 5, a navigation system 6, a human machine interface (HMI) 7 and an actuator 8 are respectively connected to the ECU 10.

The external sensor 2 is a detection device that detects an external situation which is information around the host vehicle. The external sensor 2 includes at least one of a camera, radar, and a laser imaging detection and ranging (LIDAR), or a communication device. The camera is an imaging device that images the external situation of the vehicle. The communication device is communication equipment that can receive a speed or the like of the preceding vehicle. The communication device may be a vehicle-to-vehicle communication device or may be a road-to-vehicle communication device.

The camera as the external sensor 2 functions as a detection unit that detects a lane marker which is provided at the right and left of a lane in which a vehicle travels, and transmits image information in which the lane larker is imaged to the ECU 10. The lane marker is, for example, a section line of the lane provided on the right and left of a road surface of the lane, and may be a white line, a yellow line, or a line of any other color. In addition, the lane marker may be any of a solid line or a dashed line, or may be any of a single line or a double line. The lane marker of the lane is recognized based on the image information from the camera, and it is possible to recognize a position of the vehicle with respect to the lane.

The camera is, for example, provided on the inside of windshield of the vehicle. The camera may be a monocular camera or may be a stereo camera. The stereo camera has two imaging units that are arranged so as to reproduce a binocular parallax. The image information from the stereo camera includes information in the depth direction. In a case where the stereo camera is used, the camera can be used as a detection unit that detects an object including a preceding vehicle or an obstacle.

The radar detects an obstacle or a preceding vehicle outside of the vehicle using a radio wave (for example, a millimeter wave). The radar detects the obstacle by transmitting the radio wave to the surroundings of the vehicle or another vehicle and receiving the wave reflected from the obstacle. The radar transmits the detected obstacle information to the ECU 10. In a case where a sensor fusion is performed in the subsequent stage, it is preferable to transmit the received information of the radio wave to the ECU 10.

The LIDAR detects the obstacle outside the vehicle or a preceding vehicle using light. The LIDAR transmits the light to the surroundings of the vehicle, measures the distance to the reflection point by receiving the light reflected from the obstacle or the like, and then, detects the obstacle. The LIDAR transmits the detected obstacle information to the ECU 10. In a case where a sensor fusion is performed in the subsequent stage, it is preferable to transmit the received information of the reflected light to the ECU 10. The camera, the LIDAR, and the radar are not necessarily provided in an overlapping manner.

The communication device is communication equipment that performs communication with outside of the vehicle, and a device that can acquire at least speed information of the preceding vehicle and position information of the preceding vehicle is used.

The GPS receiver 3 receives signals from three or more GPS satellites and measures the position of the host vehicle (for example, the latitude and longitude of the vehicle). The GPS receiver 3 transmits the measured position information of the vehicle to the ECU 10. Instead of the GPS receiver 3, another means for specifying the latitude and the longitude of the vehicle may be used. In addition, it is preferable for the UPS receiver 3 to have a function of measuring the orientation of the vehicle in order to collate the result of measuring by the sensors and map information described below.

The internal sensor 4 is a detection device that detects the travelling state of a vehicle which is the host vehicle. The internal sensor 4 includes at least one of a vehicle speed sensor, an acceleration sensor, and a yaw rate sensor. The vehicle speed sensor is a detection device that detects the speed of the host vehicle. As the vehicle speed sensor, for example, a wheel speed sensor is used, which is provided on vehicle wheels of the host vehicle or a member such as a drive shaft rotating integrally with vehicle wheels and detects a rotational speed of the vehicle wheels. The vehicle speed sensor transmits the detected vehicle speed information (vehicle wheel speed information) to the ECU 10.

The acceleration sensor is a detection device that detects an acceleration of the vehicle. The acceleration sensor includes, for example, a longitudinal acceleration sensor that detects acceleration in the longitudinal direction of the vehicle and a lateral acceleration sensor that detects a lateral acceleration of the vehicle. The acceleration sensor transmits, for example, the acceleration information of the vehicle to the ECU 10. The yaw rate sensor is a detection device of the vehicle that detects a yaw rate around the vertical axis of the center of gravity of the vehicle (rotational angular velocity). As the yaw rate sensor, for example, a gyro sensor can be used. The yaw rate sensor transmits the detected yaw rate information of the vehicle to the ECU 10.

The map database 5 is a database in which map information is included. The map database 5 is formed, for example, in a hard disk drive (HDD) mounted on the vehicle. In the map information, for example, position information of roads, information on road types (for example, number of lanes, types of lane such as an overtaking lane and a travelling lane), and position information of intersections, and branch points are included. Furthermore, in order to use the position information of a shielding structure such as a building or a wall and the simultaneous localization and mapping technology (SLAM), it is preferable that the map information include an output signal of the external sensor 2. The map database may be stored in a computer in a facility such as an information processing center which is capable of communicating with a vehicle.

The navigation system 6 is a device configured to perform guidance to a destination set by a driver of the vehicle for a driver of the vehicle. The navigation system 6 calculates a travel route of a vehicle based on the position information of the vehicle measured by the GPS receiver 3 and the map information in the map database 5. The route may be a route on which a preferable lane is specified in a road section of multi-lane. The navigation system 6 calculates, for example, a target route from the position of the vehicle to the destination and performs notification to the driver of the target route by displaying on a display or a voice output through a speaker. The navigation system 6, for example, transmits the target route information of the vehicle to the ECU 10. The navigation system 6 may be stored in a computer in a facility such as an information processing center which is capable of communicating with a vehicle.

The HMI 7 is an interface that performs an input and output of information between occupants (including the driver) and the travel control apparatus 1. The HMI 7 includes, for example, a display panel for displaying the image information for the driver, a speaker for audio output, and an operation button or a touch panel for the driver to perform the input operation. For example, when an input operation for starting or stopping the autonomous driving control or the travel control is performed by the occupant, the HMI 7 outputs a signal to the ECU 10, and start or stops the autonomous driving control or the travel control. When the vehicle arrives at the destination where the autonomous driving control or the travel control ends, the HMI 7 notifies the occupants of the arrival at the destination. The HMI 7 may perform the outputting of the information using a wirelessly connected mobile information terminal or may receive an input operation of the occupant using the mobile information terminal.

The actuator 8 is a device that executes an autonomous driving control including the travel control of the host vehicle. The actuator 8 includes at least a throttle actuator, a brake actuator, and a steering actuator. The throttle actuator controls a supply amount (throttle opening degree) of air to an engine according to a control signal from the ECU 10, and controls the driving power of the vehicle. In a case where the vehicle is a hybrid vehicle or an electric vehicle, the driving power is controlled by the control signal from the ECU 10 being input to a Motor which is a source of the driving force.

The brake actuator controls a brake system according to the control signal from the ECU 10 and controls the braking power given to the wheels of the vehicle. For example, a hydraulic brake system can be used as the brake system. The steering actuator controls the driving of an assist motor that controls steering torque in the electric power steering system according to the control signal from the ECU 10. In this way, the steering actuator controls the steering torque of the vehicle.

The ECU 10 includes an external situation recognition unit 11, a vehicle position recognition unit 12, a travelling state recognition unit 13, a travel plan generation unit 14, and a travel control unit 15.

The external situation recognition unit 11 recognizes external situations of the vehicle which is the host vehicle based on the detection results (for example, image information from the camera, obstacle information from the radar, and obstacle information from the LIDAR) of the external sensor 2. The external situation includes, for example, a road width, a shape of the road (for example, a curvature of the travelling lane, a gradient change effective for estimating the prospects of the external sensor 2, an undulation, an intersection, branching, merging, and the like of roads), a situation of another vehicle around the vehicle (for example, a position of the preceding vehicle, a speed of the preceding vehicle, and the like), and a situation of obstacles around the vehicle (for example, information for distinguishing a fixed obstacle and a moving obstacle, a position of the obstacle with respect to the vehicle, a moving direction of the obstacle with respect to the vehicle, a relative speed of the obstacle with respect to the vehicle, and the like). In addition, accuracies of the position and the direction of the vehicle acquired from the GPS receiver 3 or the like may be supplemented by collating the result of the detection by the external sensor 2 and the map information. The external situation recognition unit 11 functions as a travelling path information acquisition unit that acquires the travelling path information of the vehicle.

The vehicle position recognition unit 12 recognizes the position of the vehicle (hereinafter, referred to as “vehicle position”) on, the map based on the position information of the vehicle received by the GPS receiver 3 and the map information in the map database 5. The vehicle position recognition unit 12 may recognize the vehicle position by acquiring the vehicle position used in the navigation system 6 from the navigation system 6. In a case where the vehicle position of the host vehicle is measured by a sensor installed outside of the vehicle such as on the road, the vehicle position recognition unit 12 may acquire the vehicle position from the sensor by communication.

The travelling state recognition unit 13 recognizes the travelling state of the vehicle which is the host vehicle based on the detection results of the internal sensor 4 (for example, the vehicle speed information from the vehicle sensor, the acceleration information from the acceleration sensor, the yaw rate information from the yaw rate sensor). For example, the vehicle speed, acceleration, and yaw rate of the vehicle are included in the travelling state of the vehicle. In addition, the travelling state recognition unit 13 may recognize the travelling direction of the vehicle based on a temporal change in the position of the vehicle. The travelling state recognition unit 13 recognizes whether or not the vehicle is travelling in a plurality of lanes including an overtaking lane. For example, based on the result of recognition by the vehicle position recognition unit 12, it is determined whether or not the vehicle is travelling in a plurality of lanes including an overtaking lane, or it is determined whether or not the vehicle is travelling in the overtaking lane.

In addition, the travelling state recognition unit 13 recognizes the travelling state of a preceding vehicle travelling preceded ahead of the vehicle. For example, the travelling state recognition unit 13 recognizes the vehicle speed, a travelling position, a travelling lane, and a state of deceleration of the preceding vehicle based on the result of the detection by the internal sensor 4 and the external sensor 2. The travelling state recognition unit 13 functions as a travelling state acquisition unit that acquires travelling state information of the vehicle and travelling state information of the preceding vehicle.

The travel plan generation unit 14 generates a target travel route of the vehicle based on the target route calculated by the navigation system 6, the vehicle position recognized by the vehicle position recognition unit 12, and the external situation (including the vehicle position and the direction) of the vehicle recognized by the external situation recognition unit 11. The target travel route is a trajectory of the vehicle on the target route. The travel plan generation unit 14 generates the travel plan such that the vehicle can travel while satisfying standards such as safety, regulatory compliance, and driving efficiency on the target route. Here, the travel plan generation unit 14 generates the target trajectory of the vehicle so as to avoid contact with obstacles based on the situation of the obstacles around the vehicle.

The target route described here also includes a travel route generated based on the external situation or the map information when, a destination is not clearly set by a driver as a travel route along the road in the “driving assistance device” disclosed in Japanese Patent No. 5382218 (WO2011/158347) or the “automatic driving device” disclosed in Japanese Unexamined Patent Publication No. 2011-1621.32.

The travel plan generation unit 14 generates the travel plan according to the generated route. That is, the travel plan generation unit 14 generates the travel plan along the target route set based on at least the external situation which is the surroundings information of the vehicle and the map information in the map database 5. It is preferable for the travel plan generation unit 14 to output the generated travel plan as a plan having a combination of two elements of a target position p on a coordinate system on which the path of the vehicle is fixed and a target speed at each target position, that is, a plurality of configuration coordinates (p, v). Here, each target position p has at least information of the x and y coordinates on the coordinate system fixed on the vehicle or information equivalent thereto. The travel plan is not particularly limited as long as it indicates the behavior of the vehicle. A target time t, for example, may be used in the travel plan instead of the target speed v, or a travel plan in which the target time t and the orientation of the vehicle at that time are added may be used.

In addition, usually, it is sufficient that the travel plan is data of roughly a few seconds from the current time, and sometimes data of several tens of seconds is needed depending on the situation such as a right turn at an intersection or an overtaking of the vehicle. Therefore, it is preferable that the number of configuration coordinates of the travel plan is variable and a distance between the configuration coordinates is also variable. Furthermore, a curve connecting the configuration coordinates may be approximated by a spline function or the like, and then, the parameters of the curve may be used as the travel plan. Any arbitrary known method can be used for the generation of the travel plan as long as the behavior of the vehicle can be indicated.

The travel plan may be data indicating a trend of the vehicle speed, the acceleration and deceleration, and the steering torque of the vehicle when the vehicle travels on the path along the target route. The travel plan may include a speed pattern, an acceleration or deceleration pattern, and a steering torque pattern of the vehicle. Here, the travel plan generation unit 14 may generate the travel plan such that the travel time (a time required for the vehicle to arrive at the destination) becomes shortest.

Incidentally, for example, the target speed pattern is data formed from a target vehicle speed set in association with the time for each target control position with, respect to the target control position set on the path in a predetermined interval (for example, one meter). The target acceleration pattern or deceleration pattern is, for example, data formed from the target acceleration or deceleration set in association with the time for each target control position with respect to the target control position set on the path in a predetermined interval (for example, one meter). The target steering pattern is, for example, data formed from the target steering set in association with the time for each target control position with respect to the target control position set on the path in a predetermined interval (for example, one meter).

The travel control unit 15 automatically controls the travelling of the vehicle based on the travel plan generated by the travel plan generation unit 14. The travel control unit 15 outputs the control signal in response to the travel plan to the actuator 8. In this way, the travel control unit 15 controls the travelling of the vehicle such that the vehicle autonomously travels in accordance with the travel plan.

In a case where there is no preceding vehicle, the travel control unit 15 performs the travel control such that the vehicle travels at the set speed along the lane. On the other hand, in a case where a preceding vehicle is present in the lane in which the vehicle travels, in principle, the travel control unit 15 performs the travel control on the vehicle so as to follow the preceding vehicle at a vehicle distance set in advance.

In a case where the vehicle is travelling on the travelling path having a plurality of lanes including an overtaking lane, the travel control unit 15 performs the travel control on the vehicle by restricting the overtaking of the preceding vehicle travelling ahead in the overtaking lane. For example, in a case where the preceding vehicle is travelling in the overtaking lane, in principle, the travel control is performed such that the vehicle does not overtake the preceding vehicle. As an exception of this example, in a case where the preceding vehicle is travelling in the overtaking lane at a speed lower than the traveling speed of the vehicle, a travel fix passing the preceding vehicle (including the overtaking) is executed to the vehicle under a predetermined condition. Here, the predetermined conditions are, for example, a case where the deceleration of the preceding vehicle is larger than a deceleration set in advance, a case where the vehicle speed of the preceding vehicle is continuously lower than the traveling speed of the vehicle in a predetermined time duration, and a case where the driver of the vehicle has an intention of overtaking the preceding vehicle.

In addition, even in a case where the preceding vehicle is travelling in the overtaking lane, if the preceding vehicle is travelling at a speed lower than the traveling speed of the vehicle and lower than the legal minimum speed, the travel control unit 15 performs the travel control such that the vehicle overtakes the preceding vehicle or change the lane to overtake the preceding vehicle.

The external situation recognition unit 11, the vehicle position recognition unit 12, the travelling state recognition unit 13, the travel plan generation unit 14, and the travel control unit 15 described above may be configured by introducing software or programs that realize the respective functions to the ECU 10. In addition, a part or all of the above units may be respectively configured by individual electronic control units.

Next, an operation of the travel control apparatus 1 in the present embodiment will be described.

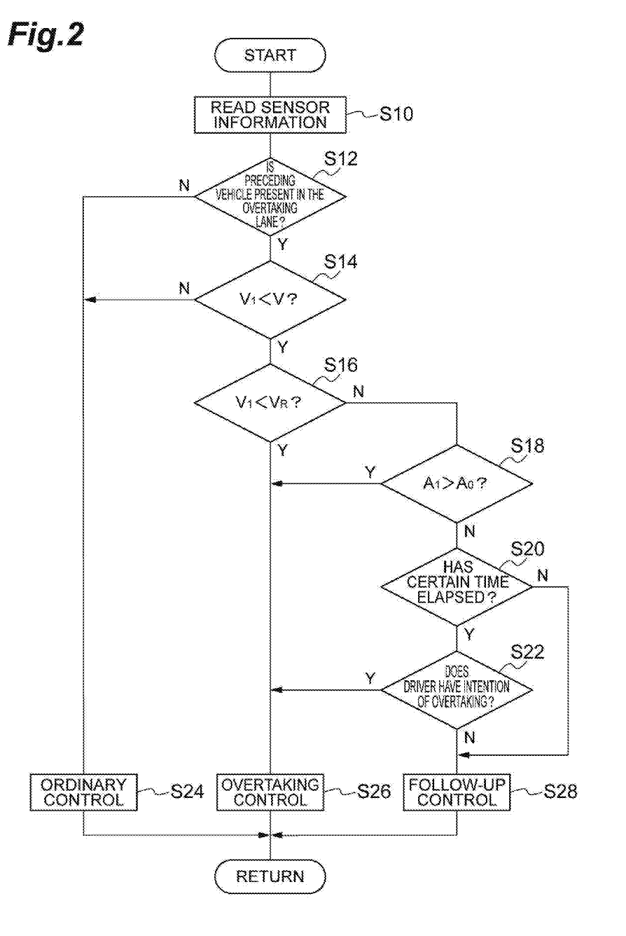

FIG. 2 is a flowchart illustrating travel control processing in the travel control apparatus 1 in the present embodiment. The travel control processing is, for example, performed at the time when the autonomous travel control is executed, and starts with the starting of the autonomous travel control. In addition, the travel control processing is performed by, for example, the ECU 10, and is repeatedly executed in a predetermined period.

As illustrated in STEP S10 in FIG. 2 (hereinafter, simply referred to as “S10”. It is similar to STEP S's hereafter), firstly, processing of reading the sensor information is performed. This processing is processing of reading the information from the external sensor 2, the GPS receiver 3, the internal sensor 4, and the navigation system 6. For example, the position information, the vehicle speed information, the deceleration information, and the like of another vehicle surrounding the vehicle including the preceding vehicle may be read as the sensor information from the external sensor 2. In addition, the vehicle speed information and the like of the vehicle which is the host vehicle are read as the sensor information from the GPS receiver 3 and the internal sensor 4. In addition, the position information of the vehicle, the lane information, of the travelling path on which the vehicle travels, and the like are read as the information from the navigation system 6.

Then, the process proceeds to S12, and it is determined whether or not a preceding vehicle is present in an overtaking lane. This determination processing is processing to determine whether or not the preceding vehicle is present within a predetermined distance from the vehicle when the vehicle is travelling in the overtaking lane. In a case where the vehicle is not travelling in the overtaking lane, if the preceding vehicle is not present in the overtaking lane, it is determined that the preceding vehicle is not present in the overtaking lane. In contrast, in a case where the vehicle is not travelling in the overtaking lane and if a preceding vehicle is present within the predetermined distance, it is determined that the preceding vehicle is present in the overtaking lane.

The overtaking lane is a lane in which the vehicle travels for overtaking in a case where a travelling path has a plurality of lanes. For example, in a case of left-hand traffic on an express way or on a motor highway, the most right lane is the overtaking lane. The predetermined distance is a distance set in advance in the ECU 10. The predetermined distance may be changed to be set according to the speed of the vehicle or the relative speed to the preceding vehicle.

In a case where it is determined that the preceding vehicle is not present in the overtaking lane in S12, ordinary travel control processing is performed (S24). This ordinary travel control processing is processing of performing the travel control to cause the vehicle to travel at a speed set in advance along the lane. The set speed is a speed set in the ECU 10 in advance. In this travel control processing, for example, a control signal is output from the ECU 10 to the actuator 8 and the steering control is performed on the vehicle along the lane by the operation of the actuator 8, and then, a drive control or a brake control is performed on the vehicle so as to travel at the set speed or according to the relative speed to the preceding vehicle.

In a case where it is determined that the preceding vehicle is present in the overtaking lane in S12, it is determined whether or not the preceding vehicle is travelling at a speed lower than the traveling speed of the vehicle (S14). This determination processing is, for example, performed by the travel control unit 15 based on the recognition information by the travelling state recognition unit 13, and it is determined whether or not a vehicle speed V₁ of the preceding vehicle is lower than a vehicle V of the vehicle. In a case where it is determined that the preceding vehicle is not travelling at the speed lower than the traveling speed of the vehicle in S14, the ordinary travel control processing is performed (S24). The content of the ordinary travel control processing is as described above.

In a case where it is determined that the preceding vehicle is travelling at the speed lower than the traveling speed of the vehicle in S14, it is determined whether or not the preceding vehicle is travelling at a speed lower than the legal minimum speed (S16). This determination processing is, for example, performed by the travel control unit 15 based on the recognition information by the travelling state recognition unit 13, and it is determined whether or not the vehicle speed V₁ of the preceding vehicle is lower than the legal minimum speed V_{R}. The legal minimum speed V_{R} is a lowest speed limit on the travelling path set by the road traffic low or the like, and for example, the information recorded in the ECU 10 based on the information from the map database 5 or the navigation system 6 may be used.

In a case where it is determined that the preceding vehicle is travelling at the speed lower than the legal minimum speed in S16, overtaking control processing is performed (S26). The overtaking control processing is processing to perform the travel control such that the vehicle overtakes the preceding vehicle. In a case where the preceding vehicle is stopped, such the case may be determined to be included in the case where the preceding vehicle is travelling at the speed lower than the legal minimum speed, the overtaking control processing may be performed. In this overtaking control processing, a control signal is output from the ECU 10 to the actuator 8 and the travel control of the vehicle is performed by the operation of the actuator 8. The overtaking control is a control to cause the vehicle to change the lane and to travel so as to pass the preceding vehicle. After passing the preceding vehicle, the vehicle may be returned to the original lane by changing the lane, or may not be returned.

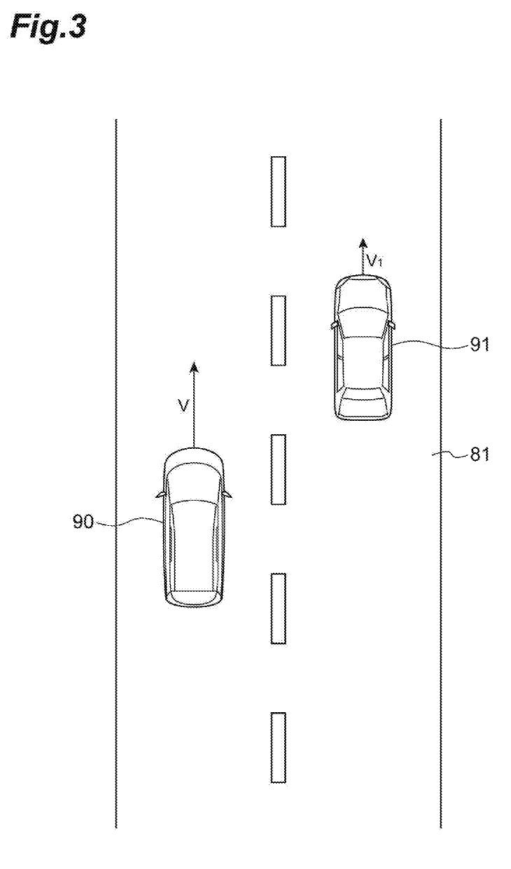

As illustrated in FIG. 3, a travel control is performed such that a vehicle (host vehicle) 90 changes the lane from an overtaking lane 81 to an adjacent lane and passes a preceding vehicle 91. At this time, the vehicle speed V of the vehicle 90 may be maintained as the previous speed before the overtaking, or may be accelerated.

In S16 in FIG. 2, in a case where it is determined that the preceding vehicle is not travelling at the speed lower than the legal minimum speed, it is determined whether or not the preceding vehicle is in a state of being decelerated by a deceleration larger than a preset deceleration (S18). This determination processing is processing for determining whether or not the deceleration A₁ is larger than the deceleration A₀ set in the ECU 10 in advance. The deceleration A₀ and the deceleration A₁ are values indicating a degree of deceleration of a vehicle, and positive values are used.

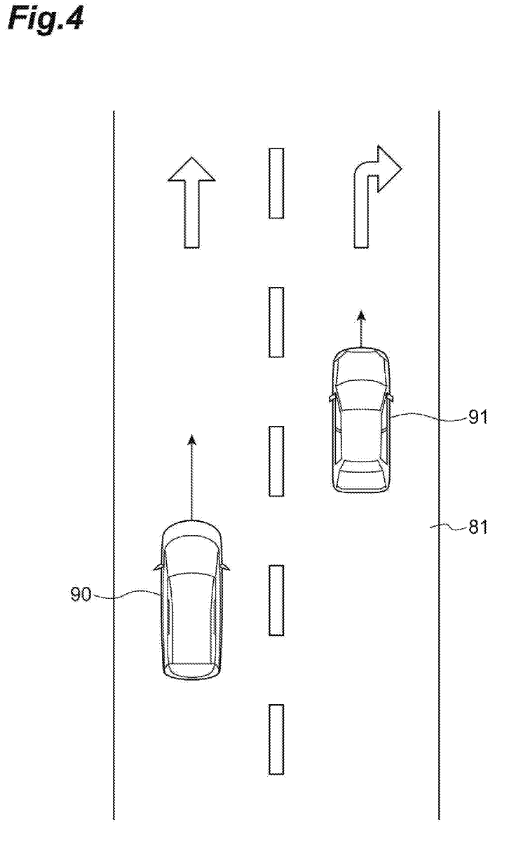

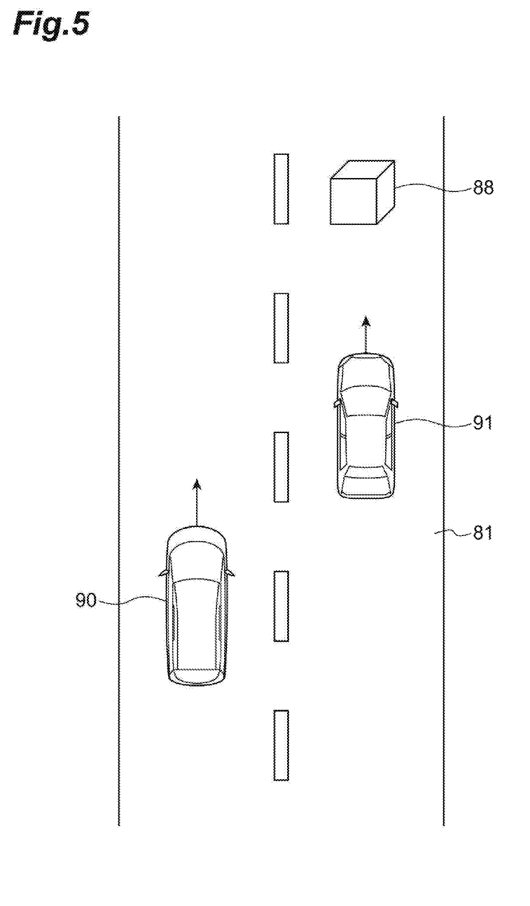

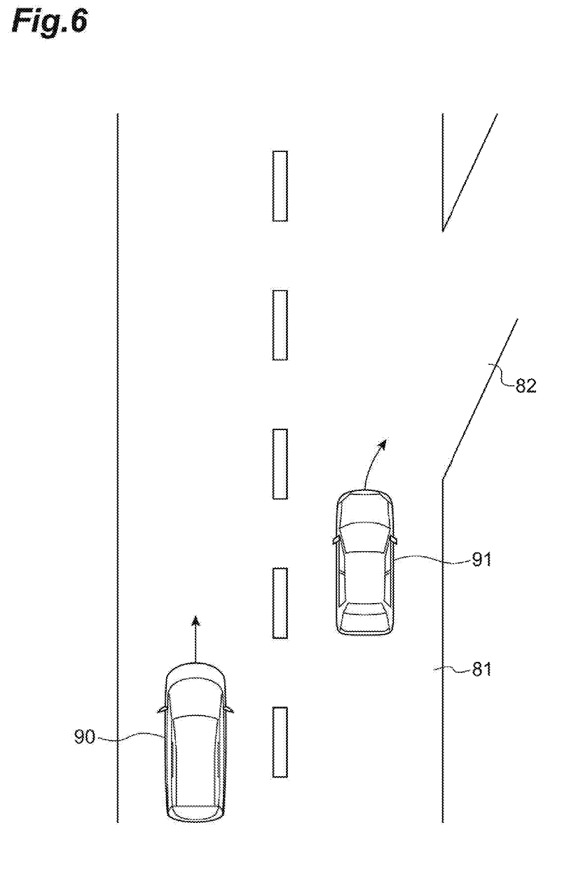

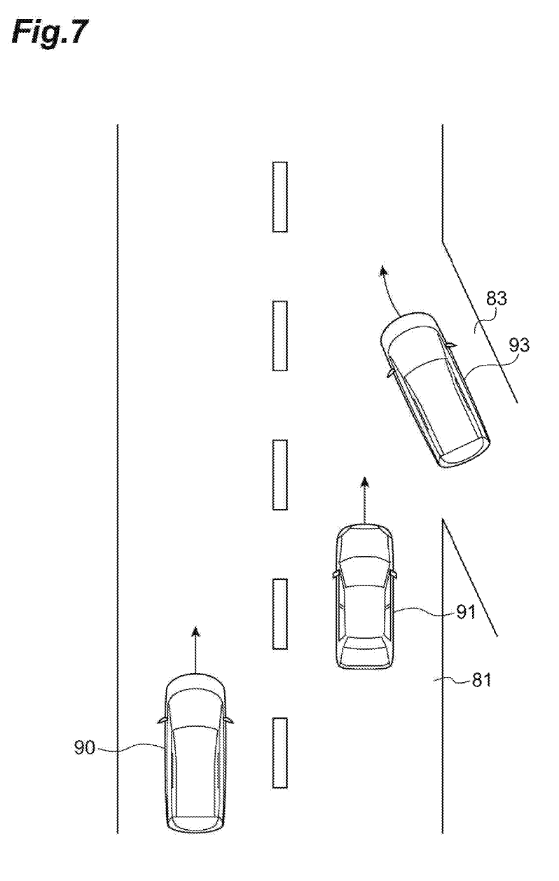

For example, a case where the preceding vehicle 91 in S18 is in the decelerating state for the right turn (refer to FIG. 4), a case where the preceding vehicle 91 is in the decelerating state for causing oncoming vehicle to pass, a case where the preceding vehicle 91 is in the decelerating state for avoiding a collision with an obstacle 88 in front of the preceding vehicle 91 (refer to FIG. 5), a case where the preceding vehicle 91 is in the decelerating state for entering a branch path 82 (refer to FIG. 6), and a case where the preceding vehicle 91 is in the decelerating state for avoiding another vehicle 93 coming from a merging path 83 (refer to FIG. 7) are the examples of the case where the preceding vehicle 91 is in a decelerating state. The deceleration state of the preceding vehicle 91 may be determined based on the result of recognition by the travelling state recognition unit 13. In addition, a reason for the deceleration state of the preceding vehicle 91 may be determined based on the recognition information from the external situation recognition unit 11. For example, an intersection of the travelling path, a presence of an oncoming vehicle, a presence of an obstacle, a branch of the travelling path, a merging of the travelling path, and a presence of merging another vehicle may be determined based on the recognition information from the external situation recognition unit 11, and then, the reason of the deceleration of the preceding vehicle 91 may be determined.

In FIG. 2, in a case where it is determined that the preceding vehicle is in a state of decelerating more than a preset deceleration in S18, the process proceeds to S26 and the overtaking control processing is performed. As described above, the overtaking control processing is processing for causing the vehicle to travel so as to overtake the preceding vehicle. On the other hand, in a case where it is determined that the preceding vehicle is not in a state of decelerating more than a preset deceleration in S18, it is determined whether or not a predetermined time has elapsed (S20). This determination processing is processing for determining whether or not the predetermined time has elapsed from a state in which the preceding vehicle travels at a speed lower than the traveling speed of the vehicle. A time set in advance in the ECU 10 may be used as the predetermined time. In a case where it is determined that the predetermined time has not elapsed in S20, the control processing ends.

On the other hand, in a case where it is determined that the predetermined time has elapsed in S20, it is determined whether or not the driver of the vehicle has an intention of overtaking the preceding vehicle (S22). In this determination processing, whether or not the driver of the vehicle has an intention of overtaking the preceding vehicle is determined based on, for example, whether or not there is an acceleration steering by the driver, whether or not a depression amount to the accelerator pedal is equal to or larger than a set amount, whether or not the amount of change in the depression amount to the accelerator pedal is equal to or larger than a set amount, whether or not a depression time of the accelerator pedal is equal to or longer than a preset time, or whether or not an operation by a dedicated operation unit that instructs the overtaking travel is performed.

In a case where it is determined that the driver of the vehicle has an intention of overtaking the preceding vehicle in S22, the process proceeds to S26, and the overtaking control processing is performed. On the other hand, in a case where it is determined that the driver of the vehicle does, not have an intention of overtaking the preceding vehicle in S22, follow-up control processing is performed (S28). The follow-up control processing is processing of controlling the travel of the vehicle so as to follow the preceding vehicle. For example, the vehicle is controlled to travel with a predetermined distance between the vehicle and the preceding vehicle such that the vehicle follows the preceding vehicle. A vehicle-to-vehicle distance value set in advance in the ECU 10 may be used as this vehicle-to-vehicle distance. In addition, the vehicle-to-vehicle distance may be a distance at which the vehicle is not determined to have caught up with the preceding vehicle or may be a distance just before catching up with the preceding vehicle. The reason for above is that, in this case, if the vehicle changes the lane without catching up with the preceding vehicle to overtake the preceding vehicle, it is not regarded as the travel of overtaking the preceding vehicle. At this time, the vehicle-to-vehicle distance may be changed according to the speed of the vehicle.

If the follow-up control processing in S28, the ordinary control processing in S24, and the overtaking control processing in S26 are finished, then, a series of control processing ends.

In the series of travel control processing in FIG. 2, as long as the result of control is not influenced, the execution of a part of the control processing may be omitted, the order of the control processing may be changed, and the another control processing may be added.

For example, in FIG. 2, the processing tasks in S18, S20, or S20 may be omitted. In this case, when it is determined that the preceding vehicle is not travelling at a speed lower than the legal minimum speed in S16, the follow-up control processing in S28 is performed.

In addition, in FIG. 2, the processing in S18 may be omitted. In this case, when it is determined that the preceding vehicle is not travelling at a speed lower than the legal minimum speed in S16, the processing tasks in S20 and S22 are appropriately performed.

In addition, in FIG. 2, the processing tasks in S20 and S22 may be omitted. In this case, when it is determined that the preceding vehicle is in a state of decelerating more than a preset deceleration in S18, the overtaking control processing is performed (S26), and in a case where it is determined that the preceding vehicle is not in a state of decelerating more than a preset deceleration in S18, the follow-up control processing is performed (S28).

In addition, in FIG. 2, the processing in S16 may be omitted. In this case, when it is determined that the preceding vehicle is travelling at the speed lower than the traveling speed of the vehicle in S14, the processing in S18 may be omitted. At this time, the processing tasks in S20 and S22 can be omitted. That is, when it is determined that the preceding vehicle is in a state of decelerating more than a preset deceleration in S18, the overtaking control processing is performed (S26), and in a case where it is determined that the preceding vehicle is not in a state of decelerating more than a preset deceleration in S18, the follow-up control processing may be performed (S28).

Furthermore, in FIG. 2, the processing tasks in S16 and S18 may be omitted. In this case, when it is determined that the preceding vehicle is travelling at the speed lower than the traveling speed of the vehicle in S14, the processing in S20 is performed.

As described above, according to the travel control apparatus in the present embodiment, in a case where it is determined that the preceding vehicle is travelling in the overtaking lane at the speed lower than the traveling speed of the vehicle, the travelling for overtaking the preceding vehicle is performed under a predetermined condition. In this way, by travelling at the speed in line with the travelling speed of the preceding vehicle, it is possible to suppress the deterioration of the traffic flow on the travelling path.

In addition, in the travel control apparatus 1 in the present embodiment, in a case where it is determined that the preceding vehicle is travelling in the overtaking lane at the speed lower than the traveling speed of the vehicle and in a case where the preceding vehicle is travelling at the speed lower than the legal minimum speed, the travelling for overtaking the preceding vehicle is performed. In this way, the travelling of the vehicle at the speed lower than the legal minimum speed is suppressed, and thus, it possible to suppress the deterioration of the traffic flow.

In addition, in the travel control apparatus 1 in the present embodiment, in a case where it is determined that the preceding vehicle is travelling in the overtaking lane at the speed lower than the traveling speed of the vehicle and in a case where the driver's intention to overtake the preceding vehicle is recognized, the travelling for overtaking the preceding vehicle is performed. In this way, the vehicle travelling in accordance with the driving attention of the driver is enabled.

Furthermore, in the travel control apparatus 1 in the present embodiment, in a case where it is determined that the preceding vehicle is travelling in the overtaking lane at the speed lower than the traveling speed of the vehicle and in a case where the preceding vehicle is in a deceleration state, the travelling for overtaking the preceding vehicle is performed. In this way, by overtaking the preceding vehicle which is in the deceleration state and not in the ordinary travelling state, it is possible to suppress the deterioration of the traffic flow on the travelling path.

In the embodiment described above, one embodiment of the travel control apparatus in the present invention is described. However, the travel control apparatus in the present invention is not limited to the embodiment described above. The travel control apparatus in the present invention may be an apparatus in which the travel control apparatus in the embodiment described above is modified without changing the gist set forth in each aspect of the invention, or may be an apparatus applied to others.

What is claimed is:

1. A travel control apparatus configured to restrict an overtaking of a preceding vehicle travelling ahead in the overtaking lane and to perform a travel control on the host vehicle when a host vehicle is travelling on a travelling path including a plurality of lanes having an overtaking lane, the apparatus comprising:
a travelling path information acquisition unit configured to acquire travelling path information of a travelling path on which the host vehicle travels;
a travelling state acquisition unit configured to acquire travelling state information of the host vehicle and travelling state information of the preceding vehicle;
a determination unit configured to determine whether or not the preceding vehicle is travelling in the overtaking lane at a speed lower than a travelling speed of the host vehicle and lower than a legal minimum speed based on the information acquired by the travelling path information acquisition unit and the travelling state acquisition unit; and
a travel control unit configured to perform a travel control of overtaking the preceding vehicle on the host vehicle in a case where it is determined that the preceding vehicle is travelling in the overtaking lane at the speed lower than the travelling speed of the host vehicle and lower than the legal minimum speed.

2. The travel control apparatus according to claim 1,
wherein the travel control unit is configured to perform the travel control of overtaking the preceding vehicle on the host vehicle when an intention of a driver of the host vehicle to overtake the preceding vehicle is recognized in a case where the preceding vehicle is travelling in the overtaking lane at the speed lower than the travelling speed of the host vehicle and not lower than the legal minimum speed.

3. The travel control apparatus according to claim 1,
wherein the travel control unit is configured to perform the travel control of overtaking the preceding vehicle on the host vehicle when the preceding vehicle is in a state of deceleration in a case where the preceding vehicle is travelling in the overtaking lane at the speed lower than the travelling speed of the host vehicle and not lower than the legal minimum speed.
